(19) United States
(12) Patent Application Publication
(10) Pub. No.: US 2021/0109960 A1
(43) Pub. Date: Apr. 15, 2021

(54) ELECTRONIC APPARATUS AND CONTROLLING METHOD THEREOF

(71) Applicant: SAMSUNG ELECTRONICS CO., LTD., Suwon-si (KR)

(72) Inventors: Hyunwoo PARK, Suwon-si (KR); Hyungtak CHOI, Suwon-si (KR); Seungsoo KANG, Suwon-si (KR); Daye LEE, Suwon-si (KR)

(21) Appl. No.: 17/034,919

(22) Filed: Sep. 28, 2020

(30) Foreign Application Priority Data
Oct. 14, 2019 (KR) 10-2019-0126755

(51) Int. Cl. G06F 16/34; G06F 40/295; G06F 16/31

(52) U.S. Cl. CPC G06F 16/345; G06F 16/313; G06F 40/295

(57) ABSTRACT

A method of controlling an electronic apparatus is provided. The controlling method of an electronic apparatus may include: receiving an original document, extracting a plurality of keywords from the received original document, structuralizing the plurality of extracted keywords, generating a summary for the received original document based on the plurality of structuralized keywords, providing the generated summary, receiving an inquiry for the provided summary, and providing a response to the inquiry based on the plurality of structuralized keywords.

### CROSS-REFERENCE TO RELATED APPLICATION

This application is based on and claims priority under 35 U.S.C. § 119 to Korean Patent Application No. 10-2019-0126755, filed on Oct. 14, 2019 in the Korean Intellectual Property Office, the disclosure of which is incorporated by reference herein in its entirety.

### BACKGROUND

### 1. Field

The disclosure relates to an electronic apparatus and a controlling method thereof, and for example, to an electronic apparatus which provides a summarized text for a text, and a controlling method thereof.

### 2. Description of Related Art

Recently, with the development of artificial intelligence technologies, technologies for a device to recognize human languages and characters, and apply and process them are increasing. In this regard, artificial intelligence technologies related to natural language processing, machine translation, conversation systems, inquiries and responses, voice recognition/synthesis, etc. are being gradually developed. In particular, recently, a technology for a device to summarize a long text and provide a summarized text to a user appeared.

However, in case a device summarizes a long text, there is a possibility that a content that a user wants may be omitted. Also, for a device to understand and summarize a long text and provide it to a user, a natural language understanding (NLU) system and a summarization system are needed, and in order for a summarization system to determine an intent included in a text, the summarization system should be subject to a natural language understanding system and use the data base (DB) and the knowledge base (KB) of the natural language understanding system.

### SUMMARY

Embodiments of the disclosure address the aforementioned problem, and provide an electronic apparatus which structuralizes keywords included in an original document using an independent database and an independent knowledge base of a summarization system, and provides information included in the original document without omitting it using a dialogue manager system technology, and a controlling method thereof.

A method of controlling an electronic apparatus according to an example embodiment of the disclosure may include: receiving an original document, extracting a plurality of keywords from the received original document, structuralizing the plurality of extracted keywords, generating a summary for the received original document based on the plurality of structuralized keywords, providing the generated summary, receiving an inquiry for the provided summary, and providing a response to the inquiry based on the plurality of structuralized keywords.

An electronic apparatus according to an example embodiment of the disclosure may include: a memory, a communication interface comprising communication circuitry, and a processor configured to control the electronic apparatus to: receive an original document using the communication interface, extract a plurality of keywords from the received original document, structuralize the plurality of extracted keywords, generate a summary for the received original document based on the plurality of structuralized keywords, provide the generated summary, and based on receiving an inquiry for the provided summary, provide a response to the inquiry based on the plurality of structuralized keywords.

A non-transitory computer readable recording medium including a program for executing a method of controlling an electronic apparatus according an example embodiment of the disclosure may include a program for executing a controlling method including: receiving an original document, extracting a plurality of keywords from the received original document, structuralizing the plurality of extracted keywords, generating a summary for the received original document based on the plurality of structuralized keywords, providing the generated summary, receiving an inquiry of a user for the provided summary, and providing a response for the inquiry of the user based on the plurality of structuralized keywords.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example system including an electronic apparatus according to an embodiment of the disclosure;

FIG. 2 is a flowchart illustrating an example method of controlling an electronic apparatus according to an embodiment of the disclosure;

FIG. 3 is a block diagram illustrating an example conversation system and a summarization system according to an embodiment of the disclosure;

FIG. 4 is a block diagram illustrating an example conversation system and a summarization system according to an embodiment of the disclosure;

FIG. 5 is a diagram illustrating an example conversation system and a summarization system according to an embodiment of the disclosure;

FIG. 6 is a diagram illustrating an example conversation system and a summarization system according to an embodiment of the disclosure;

FIG. 7A is a diagram illustrating an example electronic apparatus combining a plurality of keyword information according to an embodiment of the disclosure;

FIG. 7B is a diagram illustrating an example electronic apparatus combining a plurality of keyword information according to an embodiment of the disclosure;

FIG. 7C is a diagram illustrating an example electronic apparatus combining a plurality of keyword information according to an embodiment of the disclosure;

FIG. 8 is a block diagram illustrating an example configuration of a system including an electronic apparatus and a user terminal apparatus according to an embodiment of the disclosure;

FIG. 9 is a sequence diagram illustrating an example operation between an electronic apparatus and a user terminal apparatus according to an embodiment of the disclosure;

FIG. 10A is a flowchart illustrating an example operation of a user terminal apparatus that received a summary according to an embodiment of the disclosure;

FIG. 10B is a diagram illustrating an example operation of a user terminal apparatus that received a summary according to an embodiment of the disclosure;

FIG. 10C is a diagram illustrating an example operation of a user terminal apparatus that received a summary according to an embodiment of the disclosure;

FIG. 11A is a flowchart illustrating an example operation of a user terminal apparatus that received a summary according to an embodiment of the disclosure;

FIG. 11B is a diagram illustrating an example operation of a user terminal apparatus that received a summary according to an embodiment of the disclosure; and

FIG. 12 is a flowchart illustrating an example method of controlling an electronic apparatus according to an embodiment of the disclosure.

### DETAILED DESCRIPTION

Hereinafter, various example embodiments of the disclosure will be described with reference to the accompanying drawings. However, it should be noted that the various example embodiments are not intended to limit the technology described in the disclosure to a specific embodiment, but they should be interpreted to include various modifications, equivalents, and/or alternatives of the embodiments of the disclosure. Also, with respect to the detailed description of the drawings, similar components may be designated by similar reference numerals.

In the disclosure, expressions such as “have,” “may have,” “include,” and “may include” should be understood as denoting that there are such characteristics (e.g., elements such as numerical values, functions, operations, and components), and the terms are not intended to exclude the existence of additional characteristics.

Also, in the disclosure, the expressions “A or B,” “at least one of A and/or B,” or “one or more of A and/or B” and the like may include all possible combinations of the listed items. For example, “A or B,” “at least one of A and B,” or “at least one of A or B” refer to all of the following cases: (1) including at least one A, (2) including at least one B, or (3) including at least one A and at least one B.

Further, the expressions “first,” “second” and the like used in the disclosure may be used to describe various elements regardless of any order and/or degree of importance. Also, such expressions are used only to distinguish one element from another element, and are not intended to limit the elements.

Also, the description in the disclosure that one element (e.g., a first element) is “(operatively or communicatively) coupled with/to” or “connected to” another element (e.g., a second element) should be understood to include that one element may be directly coupled to the another element, or the one element may be coupled to the another element through still another element (e.g., a third element). The description that one element (e.g., a first element) is “directly coupled” or “directly connected” to another element (e.g., a second element) should be understood to include that still another element (e.g., a third element) does not exist between the one element and the another element.

In addition, the expression “configured to” used in the disclosure may be interchangeably used with other expressions such as “suitable for,” “having the capacity to,” “designed to,” “adapted to,” “made to” and “capable of,” depending on cases. Meanwhile, the term “configured to” does not necessarily refer, for example, to a device being “specifically designed to” in terms of hardware. Instead, under some circumstances, the expression “a device configured to” may refer, for example, to the device being “capable of” performing an operation together with another device or component. For example, the phrase “a sub-processor configured to perform A, B, and C” may refer, for example, to a dedicated processor (e.g., an embedded processor) for performing the corresponding operations, or a generic-purpose processor (e.g., a CPU or an application processor) that can perform the corresponding operations by executing one or more software programs stored in a memory device.

Hereinafter, the disclosure will be described in greater detail with reference to the drawings.

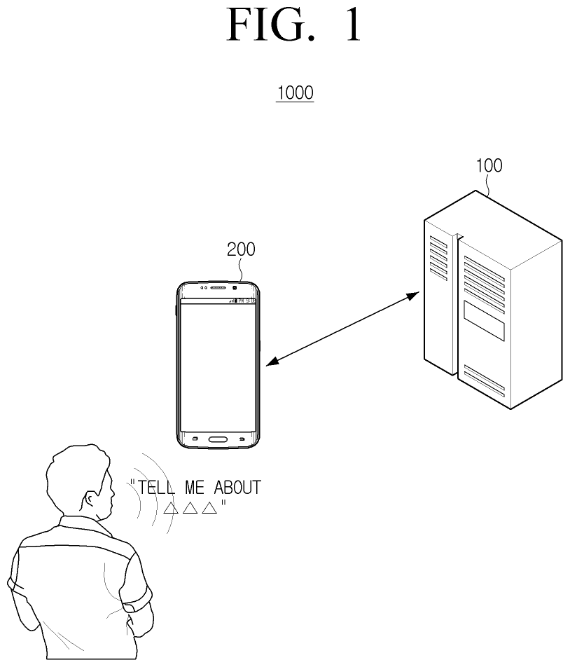

FIG. 1 is a diagram illustrating an example system including an electronic apparatus according to an embodiment of the disclosure.

As illustrated in FIG. 1, the system 1000 may include an electronic apparatus 100 and a user terminal apparatus 200.

The user terminal apparatus 200 may provide a summarized text (or a summary) for a specific document to a user. In the disclosure, a summarized text may refer, for example, to a text which includes keywords extracted from an original document, and has a shorter length than the length of the original document. A specific document may not only include an original document or text stored in the user terminal apparatus 200 but also an original document or text that the user terminal apparatus 200 received from the electronic apparatus 100 or another external apparatus (not shown).

The user terminal apparatus 200 may provide a summarized text to a user by displaying the text on a display. The user terminal apparatus 200 may convert a summarized text into a voice signal and provide the converted voice signal to a user through a speaker.

The user terminal apparatus 200 may receive an inquiry of a user related to an original document. In the disclosure, an inquiry of a user related to an original document may not only include an inquiry of a user regarding the detailed content of an original document but also a request of a user regarding an entire original document. For example, in case an original document including a specific word ΔΔΔ exists, an inquiry of a user related to the original document may not only refer to an inquiry related to the detailed content of the original document such as ‘In which region is ΔΔΔ located?’ and ‘Tell me more about ΔΔΔ’ but also a request regarding the entire original document such as ‘Tell me more about it’ and ‘It's too long. Summarize it to be shorter.’

The user terminal apparatus 200 may include various input interfaces. The user terminal apparatus 200 may include, for example, and without limitation, a microphone and receive a user voice, and/or include input interfaces such as a keypad, a button, etc. and receive input of a user inquiry. The user terminal apparatus 200 may include a display including a touch screen as a component, and display a UI performing a function related to a text on a display, and receive a user inquiry through a user input touching the UI displayed on the display.

The user terminal apparatus 200 may perform communication with the electronic apparatus 100 to provide a summarized text for an original document to a user. The user terminal apparatus 200 may transmit an original document or a user inquiry regarding an original document to the electronic apparatus 100, and receive a summarized text from the electronic apparatus 100.

The electronic apparatus 100 may include a conversation system and a summarization system.

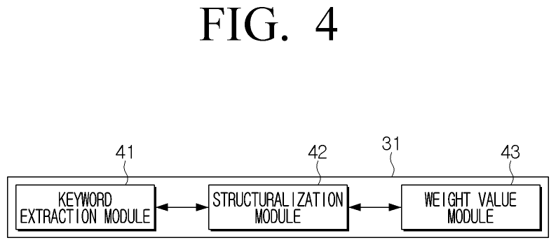

The electronic apparatus 100 may determine an intent included in an original document or a summarized text using the summarization system disclosed in the drawings below, e.g., FIG. 4. An original document or a summarized text may not only include a document or a text received from the user terminal apparatus 200, but also a document or a text stored in the electronic apparatus 100 in advance. The electronic apparatus 100 may determine an intent included in a user inquiry related to an original document or a summarized text using a conversation system, and map the intent included in the user inquiry to the intent included in the original document or the summarized text and generate an updated summarized text according to the user intent. In addition, the electronic apparatus 100 may provide the updated summarized text generated to the user terminal apparatus 200.

In FIG. 1, the user terminal apparatus 200 is illustrated as a smartphone, but this is merely an example, and the user terminal apparatus 200 may be implemented as various types of terminal apparatuses. For example, the user terminal apparatus 200 may include various electronic apparatuses such as, for example, and without limitation, a TV, a monitor, a tablet PC, a laptop computer, a PC, a kiosk, a speaker, etc.

In FIG. 1, it is illustrated that the electronic apparatus 100 is implemented as a separate apparatus from the user terminal apparatus 200 and the electronic apparatus 100 and the user terminal apparatus 200 perform communication, but the disclosure is not necessarily limited thereto.

The electronic apparatus 100 may perform the function of the user terminal apparatus 200, and the aforementioned function of the user terminal apparatus 200 may be implemented in the electronic apparatus 100. The electronic apparatus 100 may receive a user inquiry related to an original document directly from the user, and provide a summarized text to the user directly. The electronic apparatus 100 may include, for example, and without limitation, a smartphone, a TV, a monitor, a tablet PC, a laptop computer, a PC, a kiosk, a speaker, etc.

Hereinafter, an electronic apparatus and a controlling method thereof according to the disclosure will be described in greater detail.

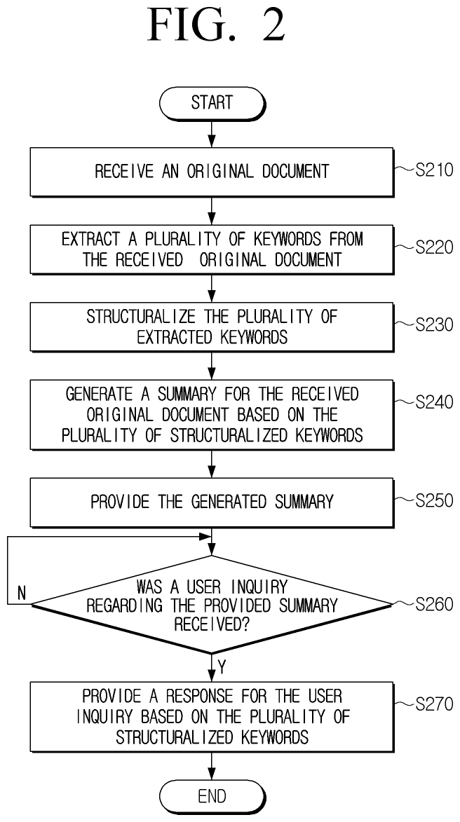

FIG. 2 is a flowchart illustrating an example method of controlling an electronic apparatus according to an embodiment of the disclosure.

In an example controlling method of an electronic apparatus according to the disclosure, an original document may be received at operation S210. An original document may refer, for example, to a document that the electronic apparatus 100 receives from an external apparatus, and may include a document received from a user terminal apparatus or a document received from an external apparatus such as a server.

A plurality of keywords may be extracted in the received original document using a summarization system at operation S220. For example, in case a word included in the original document is a keyword included in a domain dictionary base, the word may be extracted as a keyword. In addition, entity information of the keyword may be acquired while extracting the keyword. For example, in case the word ‘Samsung’ exists in the entity information ‘name’ included in the domain ‘company,’ the processor 130 may determine the word ‘Samsung’ included in the original document as a keyword, and determine that the domain of ‘Samsung’ is ‘company’ and the entity is ‘name’

The plurality of extracted keywords may be structuralized based on correlation among the keywords using the summarization system at operation S230. Structuralizing the plurality of keywords may refer, for example, to classifying or clustering the plurality of keywords in groups of keywords related to one another, and expressing the plurality of classified keywords in the form of a tree structure. A tree form is merely an example, and the plurality of keywords can be expressed in forms of various data structures.

For example, the plurality of keywords may be classified based on the entities of the keywords using a domain dictionary base including the entity information of the keywords, and keywords related to one another may be clustered.

The plurality of clustered keywords may be structuralized in a tree form using a domain knowledge base including a hierarchical structure among the entity information of the keywords. For example, by generating nodes including the entity information of the keywords, and generating a tree by arranging the nodes according to the hierarchical structure information of each entity stored in the domain knowledge base, the plurality of extracted keywords may be structuralized.

A summary (or a summarized text) for the received original document may be generated based on the plurality of structuralized keywords at operation S240, and the generated summary may be provided to the user terminal apparatus 200. For example, a summary for the original document may be generated based on weight values allotted to each of the plurality of structuralized keywords, and the generated summary may be provided to the user terminal apparatus 200.

A user inquiry for the original document may be received at operation S260-Y. When a user inquiry is received, the user intent included in the received user inquiry may be determined using the conversation system.

A response for the user inquiry may be provided based on the plurality of structuralized keywords, on the basis of the determined user intent at operation S270. The user inquiry may not only include a user inquiry for the original document but also a user request related to the original document. For example, the user inquiry may not only include an inquiry regarding a detailed content related to a specific keyword included in a text such as ‘Tell me the phone number of ΔΔΔ’ but also a request for the entire document such as ‘Tell me more about it.’

In case a user inquiry is an inquiry related to a specific keyword included in an original document or a summarized text, information related to the keyword related to the user inquiry may be extracted and provided to the user based on the plurality of structuralized keyword information. In case a user inquiry is a request for an original document or a summarized text itself, thresholds for keywords included in the plurality of structuralized keyword information may be set according to the intent included in the user inquiry, and a keyword for the user inquiry may be extracted and a response may be provided.

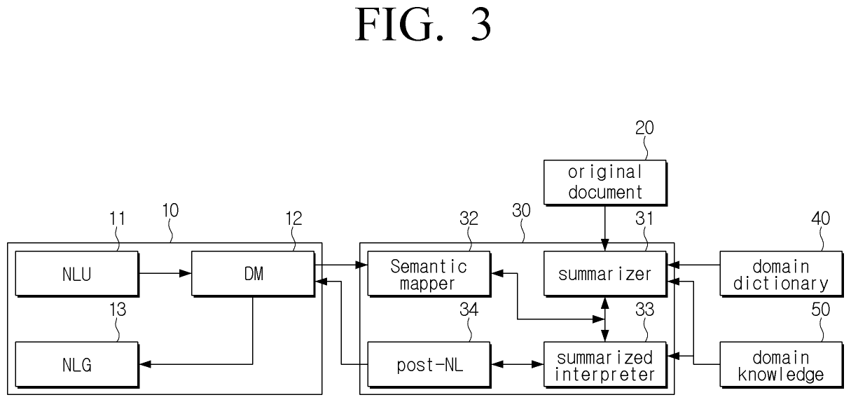

FIGS. 3, 4, 5 and 6 (which may be referred to hereinafter as FIGS. 3 to 6) are diagrams illustrating example conversation systems and a summarization systems according to an embodiment of the disclosure.

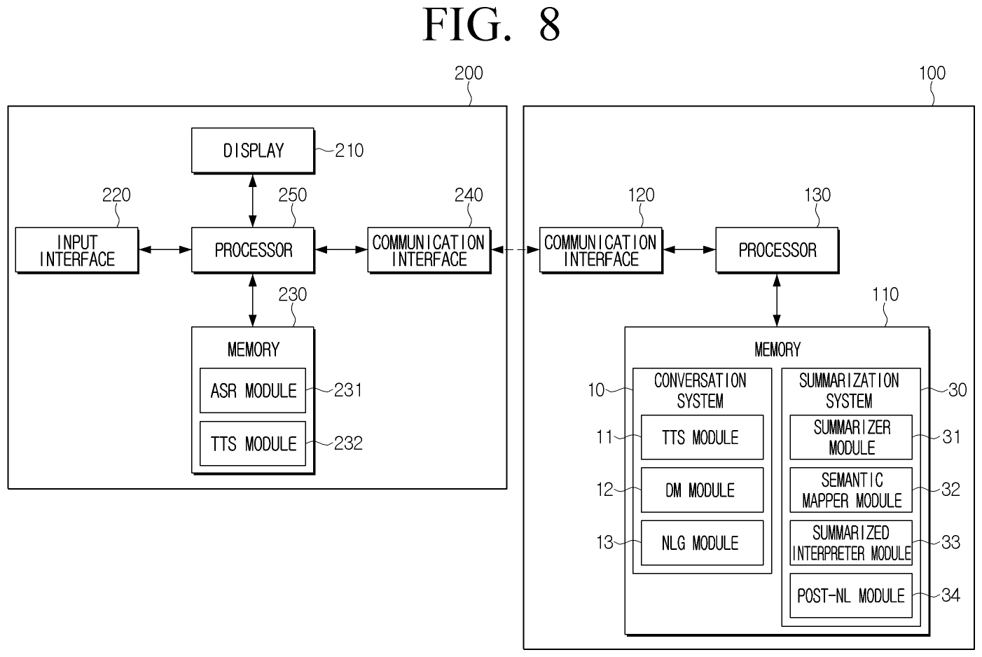

The conversation system 10 may include a component for performing a conversation with a user of the user terminal apparatus 200 through a natural language, and according to an embodiment of the disclosure, the conversation system 10 may be stored in the memory 110 (refer to FIG. 8) of the electronic apparatus 100. However, this is merely an example, and at least one component included in the conversation system 10 may be included in at least one external server.

As illustrated in FIG. 3, the conversation system 10 may include a natural language understanding (NLU) module (e.g., including processing circuitry and/or executable program elements) 11, a dialogue manager (DM) module (e.g., including processing circuitry and/or executable program elements) 12, and a natural language generator (NLG) module (e.g., including processing circuitry and/or executable program elements) 13.

The natural language understanding module 11 may include various processing circuitry and/or executable program elements and perform syntactic analysis or semantic analysis, and understand a user intent included in a user inquiry. In a syntactic analysis, a user input may be divided into grammatical units (e.g., words, phrases, morphemes, etc.), and it may be figured out which syntactic element a divided unit has. Semantic analysis may be performed using semantic matching, rule matching, formula matching, etc. Accordingly, the natural language understanding module 11 may acquire a domain which a user inquiry belongs to, an intent, or an entity (or, a parameter, a slot) necessary for expressing an intent.

The natural language understanding module 11 may determine a user intent and an entity included in a user inquiry using matching rules divided into a domain, an intent, and an entity (or, a parameter, a slot) necessary for identifying an intent. For example, the one domain (e.g., an alarm) may include a plurality of intents (e.g., setting of an alarm, release of an alarm, etc.), and one intent may include a plurality of entities (e.g., time, the number of repetition, an alarming sound, etc.). The plurality of rules may include, for example, at least one essential element entity. The matching rules may be stored in a natural language understanding database (NLU DB) (not shown).

The natural language understanding module 11 may determine a user intent by calculating how many words extracted from a user inquiry are included in the various domains and intents stored in the natural language understanding database (not shown). According to an embodiment of the disclosure, the natural language understanding module 11 may determine an entity of a word included in a user inquiry using words which became a basis for identifying an intent. As above, the natural language understanding module 11 may determine a user intent using the natural language understanding database (not shown) storing linguistic characteristics for identifying the intent of a user inquiry.

The domain and intent of a user inquiry acquired through the natural language understanding module 11 and entity information of the plurality of inquiry keywords included in the user inquiry may be transmitted to a conversation manager module 12.

The conversation manager module 12 may include various processing circuitry and/or executable program elements and determine whether a user intent identified by the natural language understanding module 11 is clear. For example, the conversation manager module 12 may determine whether a user intent is clear based on whether there is enough information of an entity included in a user inquiry. According to an embodiment of the disclosure, in case a user intent is not clear, the conversation manager module 12 may perform a feedback requesting necessary information to the user terminal apparatus 200. For example, the conversation manager module 12 may perform a feedback requesting information of an entity for identifying the intent of a user inquiry. The conversation manager module 12 may generate a message for identifying a user inquiry including a text modified by the natural language understanding module 11 and output the message. In case a user intent is clear, the conversation manager module 12 may transmit the domain and the intent of the user inquiry and entity information of the plurality of inquiry keywords included in the user inquiry to a summarization system 30.

The conversation manager module 12 may receive information related to a generated summarized text from the summarization system 30. The information related to the summarized text may include keyword information necessary for generating a summarized text and also, keyword information reconstructed to suit a user intent or grammar. The conversation manager module 12 may transmit the information of a summarized text received from the summarization system 30 to a natural language generation module 13.

The natural language generation module 13 may include various processing circuitry and/or executable program elements and change the information of a summarized text received from the conversation manager module 12 in the form of a text. That is, the natural language generation module 13 may generate a summarized text from the information related to a summarized text acquired from the summarization system.

In the disclosure, it is illustrated that the conversation system 10 includes the natural language understanding module 11, the conversation manager module 12, and the natural language generation module 13. However, in case the electronic apparatus 100 is implemented as a user terminal apparatus including the function of the user terminal apparatus 200, e.g., in case the electronic apparatus 100 is implemented as an on-device, the electronic apparatus 100 may receive a voice from a user directly, and provide a voice to a user directly. In this case, the conversation system 10 may include an automatic speech recognition (ASR) module (not shown) converting information in the form of a voice into a text form and a text to speech (TTS) module (not shown) converting information in a text form into a voice form.

The summarization system 30 may refer, for example, to a component for changing a long text or an original document into a summarized text including words less than a predetermined number, and it may be implemented as a software module. According to an embodiment of the disclosure, the summarization system 30 may be stored inside the memory 110 (refer to FIG. 8) of the electronic apparatus 100. However, this is merely an example, and at least one component included in the summarization system 30 may be included in at least one external server.

As illustrated in FIG. 3, the summarization system 30 may include a summarizer module (e.g., including processing circuitry and/or executable program elements) 31, a semantic mapper module (e.g., including processing circuitry and/or executable program elements) 32, a summarized interpreter module (e.g., including processing circuitry and/or executable program elements) 33, and a post-NL module (e.g., including processing circuitry and/or executable program elements) 34.

Each module included in the summarization system 30 will be described in greater detail below with reference to FIGS. 4, 5 and 6.

FIG. 4 is a diagram illustrating an example summarizer module according to an embodiment of the disclosure.

As illustrated in FIG. 4, the summarizer module 31 may include a keyword extraction module (e.g., including processing circuitry and/or executable program elements) 41, a structuralization module (e.g., including processing circuitry and/or executable program elements) 42, and a weight value module (e.g., including processing circuitry and/or executable program elements) 43.

The keyword extraction module 41 may include various processing circuitry and/or executable program elements and receive input of an original document 20 and acquire keywords included in the original document and entity information of the keywords. For this, the summarizer module 31 may use a domain dictionary base 40 (refer to FIG. 3) and a domain understanding base or domain knowledge base 50 (refer to FIG. 3).

In the domain dictionary base 40, a plurality of domain information and a plurality of entity information related to each domain may be stored, and a plurality of words that may have each entity information as an entity may be stored.

In the domain understanding base 50, the correlation between the domains and the plurality of entity information may be stored. For example, in the domain understanding base 50, information that the entity information ‘company name,’ ‘address,’ ‘contact number,’ ‘contact time,’, etc. are entities included in the domain ‘company’ may be stored.

In the domain understanding base 50, weight values for domains or entity information included in domains may be stored. The weight values for each domain or entity information included in domains may be stored in advance through a statistical method from big data. However, the disclosure is not necessarily limited thereto, and weight values may be stored in advance in the domain understanding base 50 according to a user setting or by a method of mixing a statistical method and a user setting.

The keyword extraction module 41 may include various processing circuitry and/or executable program elements and extract a plurality of keywords among a plurality of words included in an original document using the domain dictionary base 40. For example, in case words included in an original document are included in the domain dictionary base 40, the keyword extraction module 41 may extract the words as keywords. Then, the keyword extraction module 41 may determine the entity information and the domains of the keywords included in the original document by identifying in which domains and entity information among the various domains and entity information stored in the domain dictionary base 40 the words included in the original document belong to.

In case it is determined that words included in an original document are included in the domain dictionary base 40, the structuralization module 42 may generate nodes corresponding to each of the keywords corresponding to the words, identification information of the keywords, and domain information of the keywords and connect each of the generated nodes. For example, the structuralization module 42 may generate connection information between each node such that a child node of a node corresponding to the domain information of the keywords is a node corresponding to the entity information, and a child node of a node corresponding to the entity information is a node corresponding to the keywords.

By repeating the aforementioned process for each word included in the original document, the structuralization module 42 may generate structuralized keyword information 35 in the form of a tree. The structuralization module 42 may determine the intent of the original document based on the entity information and the domain information of the keywords included in the original document.

The weight value module 43 may include various processing circuitry and/or executable program elements and add weight values to the domains, entity information, and nodes corresponding to keywords in the keyword information based on weight values for each domain or each entity information stored in advance in the domain understanding base 50. The weight value module 43 may add weight values to the domains, entity information, and nodes corresponding to keywords included in a tree in consideration of the font sizes, font thickness or font types of the words included in the original document 20, and the frequency of the words in the original document, etc., as well as the weight values stored in advance in the domain understanding base 50. For example, in case the weight value of the entity ‘percentage’ in the domain understanding base 50 is set in advance as 0.5, but the font size of the keyword ‘40%’ corresponding to the entity ‘percentage’ in the original document 20 is bigger than the font sizes of other words in the original document 20, the weight value module 43 may set the weight value of a node corresponding to ‘percentage’ as 0.7 which is larger than 0.5. Components in consideration of weight values such as the font sizes, font thickness or font types of the words included in the original document 20, and the frequency of the words in the original document are merely an example, and the disclosure is not necessarily limited thereto.

Structuralized keyword information generated by the summarizer module 31 may be stored in the memory 110. In case there are a plurality of original documents stored in advance in the electronic apparatus 100, keyword information for the plurality of original documents may be stored in the memory 110.

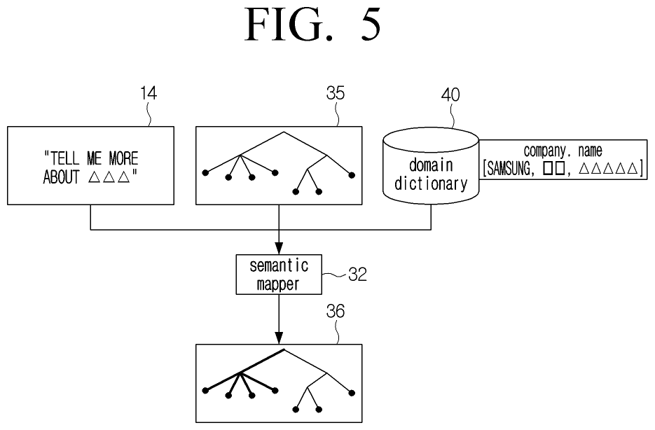

FIG. 5 is a diagram illustrating an example semantic mapper module according to an embodiment of the disclosure.

The semantic mapper module (e.g., including processing circuitry and/or executable program elements) 32 may map the intent of a user inquiry acquired in the conversation system 10 and the intent of the original document acquired in the summarizer module 31 and determine the intent of the original document having the highest relevance to the intent of the user inquiry.

The semantic mapper module 32 may include various processing circuitry and/or executable program elements and set the domain, intent, and entity information of inquiry keywords of a user inquiry acquired through the conversation system 10 as inputs. In addition, the semantic mapper module 32 may set not only the domain, intent, and entity information of inquiry keywords of a user inquiry acquired from the conversation system 10, but also the structuralized keyword information 35 generated through the summarizer module 31 and the domain dictionary base 40 as inputs of the semantic mapper module 32.

Further, the semantic mapper module 32 may generate path information in the structuralized keyword information using the aforementioned input values. The path information may include, for example, information on the keywords in the original document necessary for generating a summarized text corresponding to the intent of the user inquiry, and it may include path information of the keywords in the structuralized keyword information 35.

The semantic mapper module 32 may compare entity information corresponding to an inquiry keyword included in a user inquiry and the inquiry keyword acquired in the conversation system 10 with entity information and keywords included in the domain dictionary base 40 and determine whether the entity information of the inquiry keyword exists in the domain dictionary base 40. For example, in case a user inquiry 14 is ‘Tell me more about ΔΔΔ,’ and information that the entity information of the inquiry keyword ‘ΔΔΔ’ is ‘company name,’ and the intent of the user inquiry is search of additional information on ΔΔΔ, is acquired from the conversation system 10, the semantic mapper module 32 may determine whether the inquiry keyword ΔΔΔ exists in the domain dictionary base 40 using the domain dictionary base 40, and acquire the domain information of the inquiry keyword ΔΔΔ (e.g., the domain of ΔΔΔ is company) from the domain dictionary base 40.

In case it is determined that the entity information of the inquiry keyword exists in the domain dictionary base 40, the semantic mapper module 32 may classify keywords related to the inquiry keyword based on the structuralized keyword information 35. For example, the semantic mapper module 32 may search nodes including entity information corresponding to the entity information of the inquiry keyword among a plurality of nodes inside the structuralized keyword information 35, and classify nodes including keywords related to the searched nodes. Keywords related to the searched nodes may include keywords corresponding to nodes existing in the subordinate level of the searched nodes.

In addition, the semantic mapper module 32 may generate path information including information of nodes including the classified keywords in the structuralized keyword information and provide the path information to the summarized interpreter module 33. The path information may include the address information of the classified nodes stored in the memory 110, but in FIG. 5, the path information including the classified nodes in the tree structure will be expressed in bold lines for the convenience of explanation.

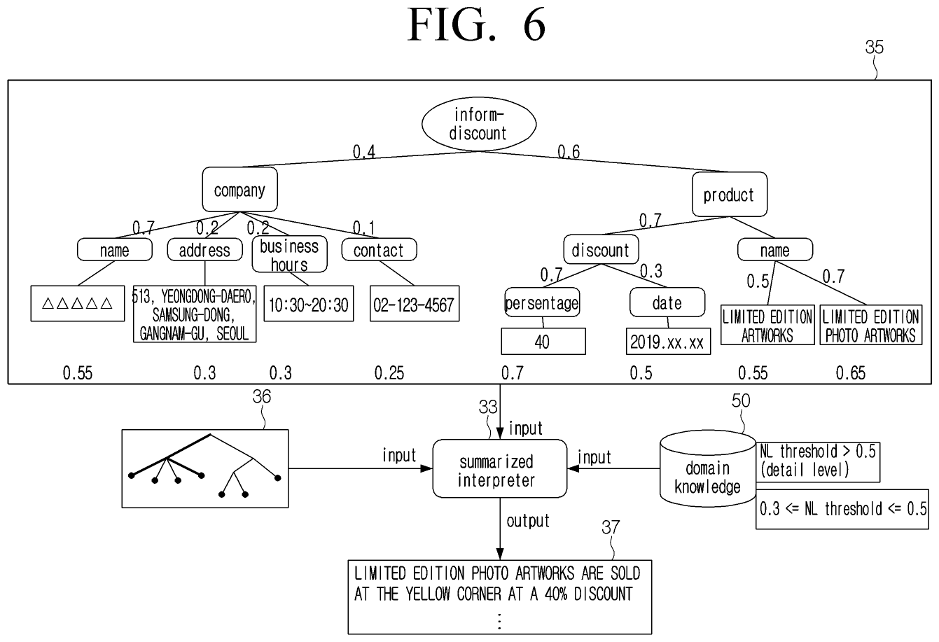

FIG. 6 is a diagram illustrating an example of the summarized interpreter module 33 according to an embodiment of the disclosure.

The summarized interpreter module 33 may include various processing circuitry and/or executable program elements and extract keywords for generating a summarized text 37 based on the structuralized keyword information 35.

The summarized interpreter module 33 may use the path information generated in the semantic mapper module 32 or a natural language (NL) threshold stored in the domain understanding base 50 as an input based on the structuralized keyword information 35 generated in the summarizer module 31. The natural language (NL) threshold stored in the domain understanding base 50 may refer, for example, to a standard for selecting a keyword node for generating a summarized text 37 among a plurality of keywords nodes (e.g., nodes including keywords) inside the structuralized keyword information 35.

In addition, the summarized interpreter module 33 may generate a summarized text based on the keyword information and the natural language threshold for the weight values of the nodes included in the keyword information. For example, in case the NL Threshold>0.5, may refer, for example, to the summarized interpreter module 33 selecting nodes of which weight values exceed 0.5 among the plurality of keyword nodes inside the structuralized keyword information 35. In case the NL Threshold>0.5 for instance, the summarized interpreter module 33 may select nodes ‘ΔΔΔ,’ ‘40,’ and ‘limited edition photo artwork’ of which weight values exceed 0.5 among the nodes including a plurality of keywords inside the structuralized keyword information 35 illustrated in FIG. 6. Then, the summarized interpreter module 33 may generate a summarized text 37 based on an entity node (e.g., a node including entity information), a domain node (a node including domain information), and a node including the intent of the text connected to the selected keyword nodes. For example, the summarized interpreter module 33 may generate a summarized text 37 such as ‘the limited edition photo artwork is sold at ΔΔΔ at a 40% discount’ based on the selected ‘ΔΔΔ,’ ‘40,’ and ‘limited edition photo artwork.’

In case 0.3<=NL Threshold<=0.5, the summarized interpreter module 33 may select nodes of which weight values are greater than or equal to 0.3 and less than 0.5, ‘513, Yeongdong-daero, Samsung-dong, Gangnam-gu, Seoul,’ ‘10:30-20:30,’ and ‘2019.XX.XX’ among the nodes including a plurality of keywords inside the structuralized keyword information 35 illustrated in FIG. 6. Then, the summarized interpreter module 33 may generate a summarized text 37 which is ‘the date of discount is 2019.XX.XX, the business hours are 10:30-20:30, and the place is 513, Yeongdong-daero, Samsung-dong, Gangnam-gu, Seoul’ based on the values of the selected nodes.

The summarized interpreter module 33 may generate a summarized text based on the keyword information 35 and the path information 36 generated in the semantic mapper module 32. Specifically, the summarized interpreter module 33 may map the path information 36 generated in the semantic mapper module 32 to the keyword information 35 and determine a keyword node, an entity node, and a domain node mapped to the path information 36 among the plurality of nodes included in the keyword information 35. Then, the summarized interpreter module 33 may generate a summarized text 37 based on the determined keyword node, entity node, and domain node.

For example, the summarized interpreter module 33 may map the path information 36 generated in the semantic mapper module 32 in FIG. 5 to the keyword information 35 and determine keyword nodes ‘ΔΔΔ ’ and ‘02-123-4567,’ and generate a summarized text 37 such as ‘the contact number of ΔΔΔ is 02-123-4567’ based on the entity node and the domain node connected to the determined keyword nodes.

As described above, the summarized interpreter module 33 may generate various summarized texts 37 according to input values based on the structuralized keyword information 35. For example, the summarized interpreter module 33 may change the natural language threshold stored in the domain knowledge base 50 and select extracted keywords, and select keywords using mapping information corresponding to inquiry keywords of a user acquired at the semantic mapper module 32. Accordingly, a summarized text 37 may be generated without omitting keywords included in an original document.

Returning to FIG. 3, the post-natural language (NL) module 34 may include various processing circuitry and/or executable program elements and acquire a summarized text 37 from the summarized interpreter module 33. The post-natural language (NL) module 34 may realign the summarized text 37 to be grammatically correct, and depending on cases, the post-natural language (NL) module 34 may perform paraphrasing of changing some of the keywords included in the summarized text 37 to other texts having the same meaning.

While, it was illustrated that in the summarization system 30 in FIG. 3, the summarizer module 31, the semantic mapper module 32, the summarized interpreter module 33, and the post-natural language (NL) module 34 are included and perform different functions from one another, the disclosure is not necessarily limited thereto. For example, depending on cases, some of the plurality of modules included in the summarization system 30 may be combined with one another and operate.

As described above, the electronic apparatus 100 may extract inquiry keywords for a user inquiry using the conversation system 10, generate keyword information for the original document using the summarization system 30, and generate a summarized text using the generated keyword information.

According to an example embodiment of the disclosure, the electronic apparatus 100 may combine a plurality of keyword information. For example, in case it is determined that the plurality of generated keyword information are related to one another, the electronic apparatus 100 may merge the plurality of keyword information related to one another, and generate one keyword information.

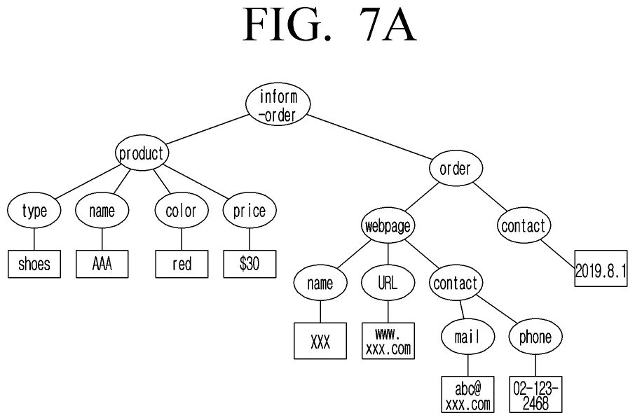

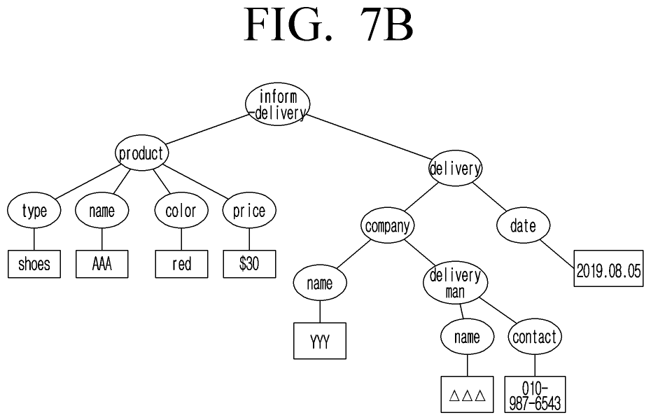

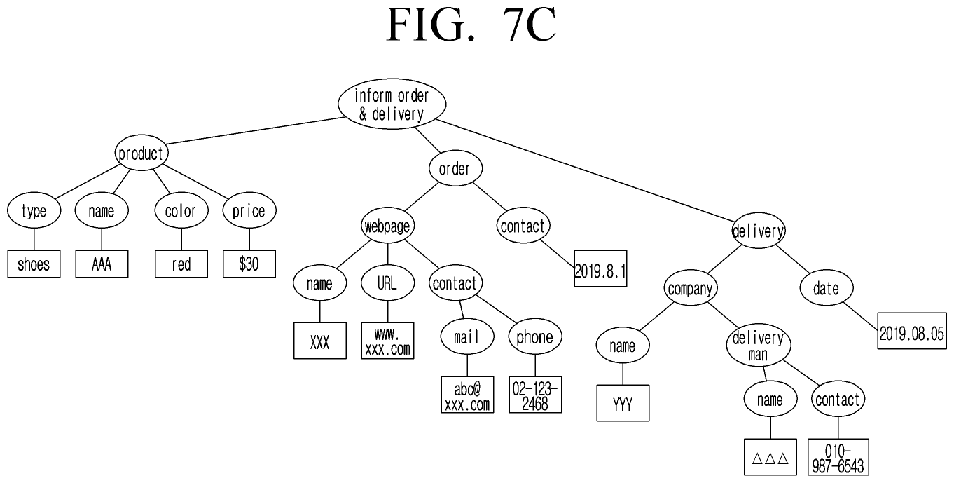

FIGS. 7A, 7B, and 7C are diagrams illustrating an example electronic apparatus combining a plurality of keyword information according to an embodiment of the disclosure.

FIG. 7A illustrates keyword information acquired through the process described above in FIGS. 2, 3 and 4, including keyword information regarding an original document including an intent of ‘information of order.’ FIG. 7B also illustrates keyword information acquired through the process described above in FIGS. 2, 3 and 4, including keyword information regarding an original document including an intent of ‘information of delivery.’

As above, the electronic apparatus 100 may receive a plurality of original documents related to one another, such as an ‘information of order’ message, an ‘information of delivery’ message, and a ‘keeping of delivery due to absence’ message for one product. In the disclosure, a second original document (e.g., an ‘information of delivery’ message, a ‘keeping of delivery due to absence’ message) related to a first original document after receiving the first original document (e.g., an ‘information of order’ message) is referred to as an additional original document for an original document.

For example, the processor 130 may receive an original document and generate keyword information 35 for the original document, and store the generated keyword information 35 in the memory 110, and then receive an additional original document related to the original document. The processor 130 may receive the additional original document from the user terminal apparatus 200, or from an external apparatus (not shown).

The processor 130 may identify the entity of each of a plurality of keywords included in the additional original document and generate structuralized keyword information for the additional original document. Explanation in this regard will overlap with the explanation regarding FIGS. 2, 3 and 4, and thus detailed explanation in this regard may not be repeated here for convenience of explanation.

In addition, the processor 130 may determine the relevance regarding the keyword information for the prestored original document and the keyword information for the additional original document. For example, the processor 130 may determine the similarity between the keyword information for the original document and the keyword information for the additional original document. Similarity may include, for example, a value numerically expressing the degree of coincidence among node information included in a plurality of keyword information, and it may refer, for example, to {the number of nodes that coincide with nodes included in keyword information of an additional original document (or an original document)}/{the number of total nodes included in keyword information of an original document (or an additional original document)}. the nodes included in the keyword information of the original document in FIG. 7A, the similarity may be {the number of nodes that coincide with the nodes included in the keyword information of the original. For example, in case the nodes ‘product,’ ‘type,’ ‘shoes,’ ‘name,’ ‘AAA,’ ‘color,’ ‘red,’ ‘price,’ and ‘$30’ among the total nodes included in the keyword information of the additional original document in FIG. 7B coincide with document}/{the number of the total nodes included in the keyword information of the additional original document}=9/21.

The processor 130 may determine whether to merge the keyword information for the original document and the keyword information for the additional original document based on the determined similarity. For example, in case the determined value of similarity is greater than or equal to a predetermined value, the processor 130 may determine that the keyword information for the original document and the keyword information for the additional original document are related with each other, and merge the two keyword information.

For example, in case it is set that a plurality of keyword information will be merged if the degree of similarity among the plurality of keyword information exceeds 0.4, the processor 130 may merge the keyword information of the additional original document in FIG. 7B with the keyword information of the original document in FIG. 7A. In this case, remaining nodes excluding the nodes overlapping with the keyword information of the original document, ‘product,’ ‘type,’ ‘shoes,’ ‘name,’ ‘AAA,’ ‘color,’ ‘red,’ ‘price,’ and ‘$30’ among the plurality of nodes included in the keyword information of the additional original document may be included in the keyword information of the original document in FIG. 7A. As the method of merging keyword information follows the method of merging trees, detailed explanation in this regard may not be repeated here.

Although it is not specifically described in FIG. 7A, FIG. 7B, and FIG. 7C, in the process of merging keyword information, the weight values of nodes that do not coincide with one another included in the keyword information may be maintained, and the weight values of nodes that coincide with one another may be reset according to the system.

The processor 130 may generate a summarized text based on the merged keyword information. For example, in case a user inquiry is ‘tell me about the delivery schedule of the product AAA,’ the processor 130 may provide a summarized text which is ‘The shoes AAA that you ordered on the XXX website will be delivered on Aug. 5, 2019 from the YYY delivery company’ based on the weight value of the merged keyword information.

As described above, the processor 130 may combine a plurality of keyword information for a plurality of original documents related to one another, and generate a summarized text for the plurality of original documents related to one another, and transmit the text to the user terminal apparatus 200.

FIG. 8 is a block diagram illustrating an example configuration of a system including an electronic apparatus and a user terminal apparatus according to an embodiment of the disclosure.

As illustrated in FIG. 8, the electronic apparatus 100 includes a memory 110, a communication interface (e.g., including communication circuitry) 120, and a processor (e.g., including processing circuitry) 130.

The memory 110 may refer, for example, to a component for storing various kinds of programs and data, etc. necessary for the operations of the electronic apparatus 100. The memory 110 may be implemented as a non-volatile memory, a volatile memory, a flash-memory, a hard disc drive (HDD) or a solid state drive (SSD), etc. Further, the memory 110 may be accessed by the processor 130, and reading/recording/correcting/deleting/updating, etc. of data by the processor 130 may be performed. Meanwhile, in the disclosure, the term memory may include a memory 110, a ROM (not shown) inside the processor 130, a RAM (not shown), or a memory card (not shown) (e.g., a micro SD card, a memory stick) installed on the electronic apparatus 100.

In the memory 110, various kinds of software modules for making the electronic apparatus 100 operate according to the various embodiments of the disclosure may be stored. Specifically, in the memory 110, a summarization system (or a summarization module) for summarizing an original document and a conversation system (or a conversation module) for determining a user intent included in a user inquiry according to the various embodiments of the disclosure may be stored.

In the memory 110, various kinds of databases necessary for the summarization system to summarize an original document may be stored. For example, in the memory 110, a domain dictionary including various words and entity information of words and a domain knowledge base including information related to entity information of words (e.g., correlation among entities, weight values for entities, etc.) may be stored.

The memory 110 may store some or all of the conversation system, the summarization system, the domain dictionary base (the first data base) and the domain knowledge base (the second data base), or store only some of them. For example, among the conversation system, the summarization system, the domain dictionary base and the domain knowledge base, only the conversation system and the summarization system may be stored in the memory 110, and the domain dictionary and domain knowledge bases may be stored in another external apparatus (not shown). In this case, the electronic apparatus 100 may acquire the data of the domain dictionary and domain knowledge bases through communication with the another external apparatus (not shown).

The communication interface 120 may include various communication circuitry for making the electronic apparatus 100 perform communication with the user terminal apparatus 200. Through the communication interface 120, the electronic apparatus 100 may receive information on an original document or a user inquiry from the user terminal apparatus 200, and transmit a summarized text to the user terminal apparatus 200.

The communication interface 120 may include various communication modules including various communication circuitry such as a wired communication module (not shown), a near field wireless communication module (not shown), a wireless communication module (not shown), etc.

A wired communication module may refer, for example, to a module for performing communication with an external apparatus (not shown) according to a wired communication method such as a wired Ethernet. A near field wireless communication module may refer, for example, to a module for performing communication with an external apparatus (not shown) located in a close distance according to a near field wireless communication method such as Bluetooth (BT), Bluetooth Low Energy (BLE), a ZigBee method, etc. A wireless communication module may refer, for example, to a module that is connected to an external network according to wireless communication protocols such as WiFi, IEEE, etc., and performs communication with an external apparatus (not shown) and a voice recognition server (not shown). Other than the above, a wireless communication module may further include a mobile communication module that accesses a mobile communication network and performs communication according to various mobile communication standards such as 3rd Generation (3G), 3rd Generation Partnership Project (3GPP), Long Term Evolution (LTE), LTE Advanced (LTE-A), and 5G Networks.

The processor 130 may include various processing circuitry and be electronically connected with the memory 110 and control the overall operations and functions of the electronic apparatus 100. For example, the processor 130 may operate an operation system or an application program and control hardware or software components connected to the processor 130, and perform various kinds of data processing and operations. Also, the processor 130 may load instructions or data received from at least one of other components on a volatile memory and process them, and store various data in a non-volatile memory.

The processor 130 may be implemented, for example, and without limitation, as a dedicated processor for performing corresponding operations (e.g., an embedded processor), as a generic-purpose processor that can perform corresponding operations by executing one or more software programs stored in a memory device (e.g., a central processing unit (CPU) or an application processor), or the like.

The processor 130 may receive a user inquiry related to an original document stored in the memory 110 in advance through the communication interface 120. Here, a user inquiry related to an original document may include a user inquiry or request regarding the content of the original document. As described above in FIG. 1, in case an original document including a specific word ΔΔΔ, exists, a user inquiry related to the original document may not only refer to an inquiry related to the detailed content of the original document such as ‘In which region is ΔΔΔ, located?’ and ‘Tell me more about ΔΔΔ,’ but also a request regarding the entire original document such as ‘Tell me more about it’ and ‘It's too long. Summarize it to be shorter.’

When the processor 130 receives a user inquiry related to an original document, the processor 130 may extract at least one inquiry keyword from the user inquiry. Specifically, the processor 130 may extract an inquiry keyword included in a user inquiry and entity information of the inquiry keyword using the conversation system stored in the memory 110. The inquiry keyword may include a keyword acquired from the user inquiry using the natural language understanding module included in the conversation system, and entity information of the inquiry keyword may include the entity (or, the parameter or the slot) of the acquired keyword. As the user inquiry is related to the original document, the inquiry keyword may correspond to a word included in the original document or the entity of a word included in the original document. Meanwhile, an inquiry keyword may be acquired through the conversation system, and for acquiring an inquiry keyword, a separate data base or artificial intelligence model from the conversation system may be used.

The processor 130 may acquire a plurality of keywords included in an original document and entity information of the keywords based on a domain dictionary base storing a plurality of keywords and entity information for each of the plurality of keywords. For example, in case a word included in an original document is a keyword included in the domain dictionary base, the processor 130 may extract the word as a keyword and acquire entity information of the word from the domain dictionary base. For example, in case an original document includes the word ‘Samsung,’ and the word ‘Samsung’ exists in the entity information ‘name’ included in the domain ‘company’ in the domain dictionary base, the processor 130 may determine the word ‘Samsung’ included in the original document as a keyword, and determine that the domain of ‘Samsung’ is ‘company’ and the entity is ‘name.’ A keyword may include a plurality of entities. For example, the keyword ‘Samsung’ may include the entities ‘company’ and ‘name.’ As described above, the processor 130 may acquire entity information of a keyword included in an original document using the data base of the conversation system or a separate data base from the knowledge base.

The processor 130 may classify keywords related to an extracted inquiry keyword among the plurality of keywords included in the original document. The processor 130 may classify keywords related to the extracted inquiry keyword and keywords not related to the extracted inquiry keyword among the plurality of keywords based on the entity information of the inquiry keyword. Also, the processor 130 may search keywords including the same entity information as the entity information of the inquiry keyword among the plurality of keywords included in the original document, and classify the searched keywords among the plurality of keywords.

For classifying keywords related to the inquiry keyword among the plurality of keywords, the processor 130 may generate keyword information for the plurality of keywords included in the original document.

The processor 130 may extract a plurality of keywords from the original document and structuralize the extracted keywords and generate keyword information. For example, the processor 130 may classify keywords based on the entity information of the keywords using the domain dictionary base (the first data base) including entity information of keywords, and cluster (or group) keywords related to one another. For this, the processor 130 may use the summarization system stored in the memory 110.

For example, the processor 130 may extract keywords related to a specific domain among the plurality of words included in the original document through the summarization system and the domain dictionary base stored in the memory 110, and identify entity information of each of the plurality of extracted keywords.

The processor 130 may cluster the plurality of keywords using the entity information identified for each of the plurality of keywords. The processor 130 may cluster the plurality of keywords using the domain knowledge base storing the correlation among the plurality of entity information. For example, in case it was determined that the entity information of the keyword ‘A’ is ‘company name,’ and the entity information of the keyword ‘B’ is ‘company address,’ and the domain knowledge base stores the entities ‘name,’ ‘address,’ and ‘contact number’ as the subordinate concepts of the entity ‘company,’ the processor 130 may determine that the ‘company name’ and ‘company address’ exist in the subordinate concepts of the entity ‘company’ and cluster the keyword A and the keyword B.

The processor 130 may structuralize the plurality of clustered keywords in the form of a tree based on the domain knowledge base (the second data base) including the hierarchical structure among the entity information of the keywords and generate keyword information. For example, the processor 130 may generate nodes including the entity information of the keywords, and arrange the nodes according to the hierarchical structure information among each entity information stored in the domain knowledge base and generate a tree.

A tree form was discussed as an example form of structuralizing a plurality of keywords, but the disclosure is not necessarily limited thereto. Different data structure forms such as alignment in the form of structuralizing keywords included in an original document may be used.

The processor 130 may classify keywords related to an inquiry keyword among a plurality of keywords included in an original document based on structuralized keyword information. The processor 130 may search keywords having entities corresponding to the entity information of the inquiry keyword among the plurality of keywords included in the original document. For example, the processor 130 may search entity information which is the same as the entity information of the inquiry keyword among the entity information of the plurality of keywords based on the keyword information, and classify keywords having the searched entity information as the entity information.

The processor 130 may combine the classified keywords and generate a summarized text for the original document. The summarized text may include, for example, a text including keywords related to the entity information of the inquiry keyword included in the user inquiry, and it may refer, for example, to a text of which number of the entire keywords included in the text is less than or equal to a predetermined number.

Prior to receiving a user inquiry related to an original document and generating keyword information, the processor 130 may generate a preview summarized text for the received original document and provide the text. The generated preview summarized text is a summarized text provided before the user terminal apparatus 200 receives a user inquiry for the original document, and it may be a summarized text including keywords selected based on the weight values of the words included in the original document.

For example, the processor 130 may generate a preview summarized text using a predetermined condition among the plurality of keywords included in the original document. For example, the processor 130 may acquire the weight values of each of the plurality of keywords included in the original document using the words and the weight values of the entity information of the words stored in the keyword knowledge base, and select keywords corresponding to the predetermined weight values among the plurality of keywords, and generate a preview summarized text. For example, the processor 130 may acquire the weight values of the plurality of keywords included in the original document, and select keywords of which weight values acquired are greater than or equal to 0.5, and generate a summarized text.

The processor 130 may generate keyword information for an original document and provide a preview summarized text. The processor 130 may receive an original document, and generate keyword information related to the original document before receiving a user inquiry related to the original document, and provide a preview summarized text. In this case, the processor 130 may acquire a plurality of keywords and the weight values of each entity information included in the keyword information based on the keyword knowledge base, and select keywords corresponding to the predetermined weight values among the plurality of keywords and the entity information, and generate a preview summarized text.

The processor 130 may transmit the generated preview summarized text to the user terminal apparatus 200 and receive a user inquiry for the original document from the user terminal apparatus 200.

As described above, the electronic apparatus 100 according to an embodiment of the disclosure may classify keywords related to a user inquiry among a plurality of keywords included in an original document using the conversation system and the summarization system stored in the memory 110, and combine the classified keywords, and generate a summarized text for the original document. Accordingly, the electronic apparatus 100 can provide a summarized text to a user without omitting the information that the user needs among the information included in the original document.

The user terminal apparatus 200 may include a display 210, an input interface (e.g., including input circuitry) 220, a memory 230, a communication interface (e.g., including communication circuitry) 240, and a processor (e.g., including processing circuitry) 250.

The display 210 may refer, for example, to a component for displaying contents such as images and texts, and it may be implemented as, for example, and without limitation, a liquid crystal display (LCD), and depending on cases, it may be implemented as a cathode-ray tube (CRT), a plasma display panel (PDP), organic light emitting diodes (OLEDs), transparent OLEDs (TOLEDs), etc.

The display 210 may display various kinds of information according to control of the processor 250. In particular, the display 210 may receive a summarized text from the electronic apparatus 100 and display the text. The display 210 may display a user inquiry for a summarized text or an original document and a response for the user inquiry.

The input interface 220 may include various input circuitry and receive a user input for controlling the user terminal apparatus 200. The input interface 220 may receive a user inquiry for a summarized text or an original document. The input interface 220 may include a microphone (not shown) for receiving an input of a user voice, a touch panel (not shown) for receiving an input of a user touch using a user's hand or a stylus pen, etc., a button (not shown) for receiving an input of a user manipulation, etc. However, these are merely examples, and the input interface 220 may be implemented as other input apparatuses (e.g., a keyboard, a mouse, etc.).

The memory 230 may refer, for example, to a component for storing various kinds of programs or data, etc. necessary for the operations of the user terminal apparatus 200. The memory 230 may be implemented as a non-volatile memory, a volatile memory, a flash-memory, a hard disc drive (HDD) or a solid state drive (SSD), etc. Further, the memory 230 may be accessed by the processor 250, and reading/recording/correcting/deleting/updating, etc. of data by the processor 250 may be performed. Meanwhile, in the disclosure, the term memory may include a memory 230, a ROM (not shown) inside the processor 250, a RAM (not shown), or a memory card (not shown) (e.g., a micro SD card, a memory stick) installed on the electronic apparatus 100.

In the memory 230, various kinds of software modules for making the user terminal apparatus 200 operate according to the various embodiments of the disclosure may be stored. Specifically, in the memory, an automatic speech recognition (ASR) module 231 and a text to speech (TTS) module 232 may be stored.

The automatic speech recognition (ASR) module 231 may convert a user input (in particular, a user inquiry) received from the user terminal apparatus 200 into text data. For example, the automatic speech recognition module 231 may include an utterance recognition module. The utterance recognition module may include an acoustic model and a language model. For example, the acoustic model may include information related to sounds, and the language model may include unit phoneme information and information on combination of unit phoneme information. The utterance recognition module may convert a user utterance into text data using the information related to sounds and the information regarding unit phoneme information. The information regarding the acoustic model and the language model may be stored, for example, in an automatic speech recognition database (ASR DB) (not shown).

The text to speech module 232 may change information in the form of a text to information in the form of a voice. Also, the text to speech module 232 may change information in the form of a text received from the electronic apparatus 100 to information in the form of a voice.

Referring to FIG. 8, it is illustrated that the memory 230 includes the automatic speech recognition module 231 and the text to speech module 232, but this is merely an example, and the automatic speech recognition module 231 and the text to speech module 232 may be stored in another external apparatus (not shown).

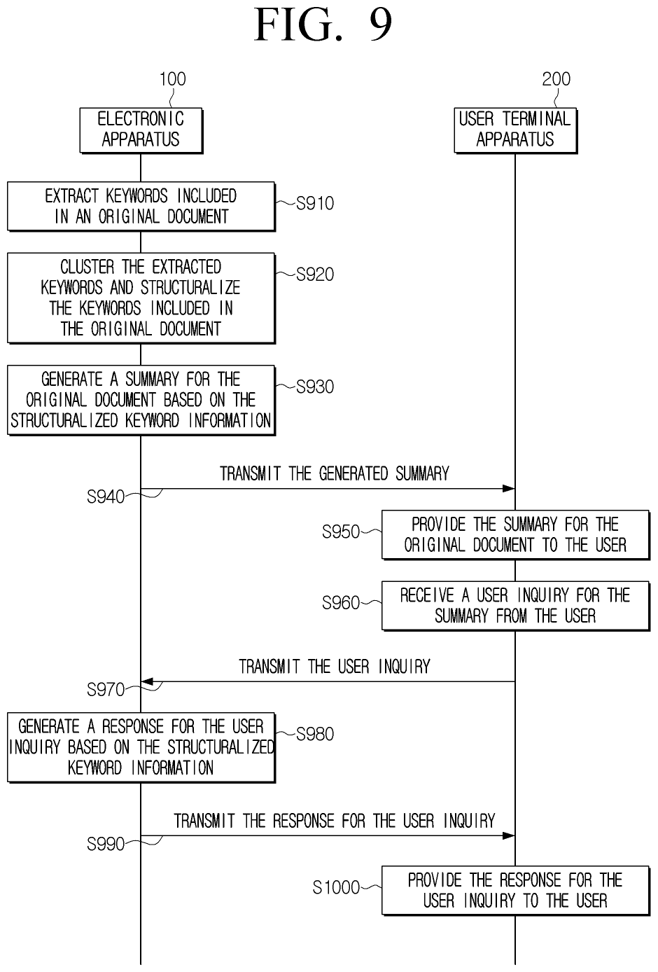

FIG. 9 is a sequence diagram illustrating an example operation between an electronic apparatus and a user terminal apparatus according to an embodiment of the disclosure.

The electronic apparatus 100 may receive and store an original document. The original document received by the electronic apparatus 100 may have been received from the user terminal apparatus 200 or an external apparatus (not shown). For example, in case it is set that the user terminal apparatus 200 receives an original document from an external apparatus (not shown), and receives a summarized text for the received original document from the electronic apparatus 100, the user terminal apparatus 200 may transmit the original document received from the external apparatus (not shown) to the electronic apparatus 100.

The electronic apparatus 100 may generate keyword information for the received original document for generating a summarized text for the received original document. For example, the electronic apparatus 100 may extract keywords included in the original document at operation S910. The electronic apparatus 100 may extract words that coincide with the words stored in the domain dictionary base 40 among the plurality of words included in the original document as keywords using the domain dictionary base 40, and identify the entities of the extracted keywords based on entity information of words stored in the domain dictionary base 40.

The electronic apparatus 100 may cluster the extracted keywords and structuralize the keywords extracted from the original document at operation S920. For example, the electronic apparatus 100 may cluster the plurality of keywords using the identified entities of the extracted keywords. The electronic apparatus 100 may identify the correlation among the entities of the plurality of keywords using the domain knowledge base 50 storing the correlation among a plurality of entity information and cluster the plurality of keywords. For example, the electronic apparatus 100 may structuralize the entities of the plurality of keywords based on the correlation among the entities, and match the keywords with the structuralized entities, and generate structuralized keyword information.

The electronic apparatus 100 may generate a summarized text for the original document based on the structuralized keyword information at operation S930, and transmit the generated summarized text to the user terminal apparatus 200 at operation S940.

For example, the electronic apparatus 100 may acquire weight values for the keyword node, entity node, and domain node included in the structuralized keyword information based on the domain knowledge base and the received original document and apply the acquired weight values to each of the keyword node, entity node, and domain node. Then, the electronic apparatus 100 may generate a summarized text based on the weight values applied to the keyword node, entity node, and domain node. For example, the processor 130 may set the NL threshold stored in the domain knowledge base as 0.5, select words of which weight values are greater than or equal to 0.5 among the keywords included in the keyword information, generate a summarized text, and transmit the text to the user terminal apparatus 200. The generated summarized text may refer, for example, to a summarized text generated before a user inquiry for the original document is received, and thus it may be a preview summarized text.

In this regard, referring to the example in FIG. 9, in case an original document 20 was received at the user terminal apparatus 200, the electronic apparatus 100 may generate a summarized text for the original document at the user terminal apparatus 200 before receiving a user inquiry for the original document 20. For example, the electronic apparatus 100 may select keywords of which weight values are greater than or equal to 0.5 in the keyword information for the original document and generate a summarized text which is ‘Photo artworks are sold at ΔΔΔ at prices discounted up to 40%,’ and transmit the text to the user terminal apparatus 200.

The electronic apparatus 100 may provide different summarized texts according to the set NL threshold. For example, even if the received original document is the same document, the electronic apparatus 100 may generate different summarized texts according to the set NL threshold. For example, in case the NL threshold is greater than or equal to 0.4, the electronic apparatus 100 may select keywords of which weight values are greater than or equal to 0.5 in the keyword information and generate a summarized text which is ‘Photo artworks are sold at ΔΔΔ at prices discounted up to 40%,’ and transmit the text to the user terminal apparatus 200.

The user terminal apparatus 200 may provide the summarized text for the original document to the user at operation S950. The user terminal apparatus 200 may provide the summarized text to the user in the form of the original document through the display, or provide the summarized text to the user in the form of a voice through the speaker.

The user terminal apparatus 200 may receive a user inquiry for the summarized text from the user at operation S960. The user inquiry may not only include a user inquiry for the original document but also a user request related to the original document. For example, the user inquiry may not only include an inquiry related to a specific keyword included in the original document such as ‘Tell me the phone number of ΔΔΔ’ but also a request related to the entire original document such as ‘Tell me more about it.’

The user terminal apparatus 200 may transmit the received user inquiry to the electronic apparatus 100 at operation S970.

The electronic apparatus 100 may generate a summarized text for the original document based on the structuralized keyword information for the original document at operation S980. For example, in case the user inquiry is ‘Tell me more about it,’ the electronic apparatus 100 may determine that the intent of the user inquiry is ‘request for detailed information,’ and set the NL threshold to be lower than before and provide a summarized text including words having lower weight values than the summarized text provided before. In case the user inquiry is ‘It's too long. Summarize it to be more shorter,’ the electronic apparatus 100 may determine that the intent of the user inquiry is ‘request for summarized information,’ and set the NL threshold to be higher than before and provide a summarized text including words having higher weight values than the summarized text provided before.

In case the user inquiry is ‘Isn't there any other content?,’ the electronic apparatus 100 may determine that the intent of the user is ‘request for the remaining information,’ and set the keywords or the NL threshold not provided to the user to be lower than before and select keywords having lower weight values than the keywords selected before, and provide a summarized text.

As another example, in case the user inquiry is ‘Tell me the phone number of ΔΔΔ,’ the electronic apparatus 100 may extract inquiry keywords included in the user inquiry (‘ΔΔΔ,’ ‘phone number’), classify keywords related to the extracted inquiry keywords (‘ΔΔΔ,’ ‘02-123-4567’) among the plurality of keywords included in the original document, and generate a summarized text including the classified keywords ‘The phone number of ΔΔΔ is 02-123-4567.’

The electronic apparatus 100 may transmit the generated summarized text to the user terminal apparatus 200 at operation S990, and the user terminal apparatus 200 may provide the received summarized text to the user at operation S1000.

In addition to generating a summarized text, the electronic apparatus 100 may generate a text for performing an interaction with the user of the user terminal apparatus. For example, the electronic apparatus 100 may generate a text for performing an interaction with the user using the conversation system 10 and provide this to the user terminal apparatus 200. For example, in case the user inquiry is ‘Tell me the phone number of ΔΔΔ,’ the electronic apparatus 100 may not only generate a summarized text ‘The phone number of ΔΔΔ is 02-123-4567,’ but also a text such as ‘Do you want me to make a call?’ and transmit the generated text to the user terminal apparatus 200. Here, in case the user's response is a positive expression, the user terminal apparatus 200 may perform a function according to the user's response (e.g., making a call).

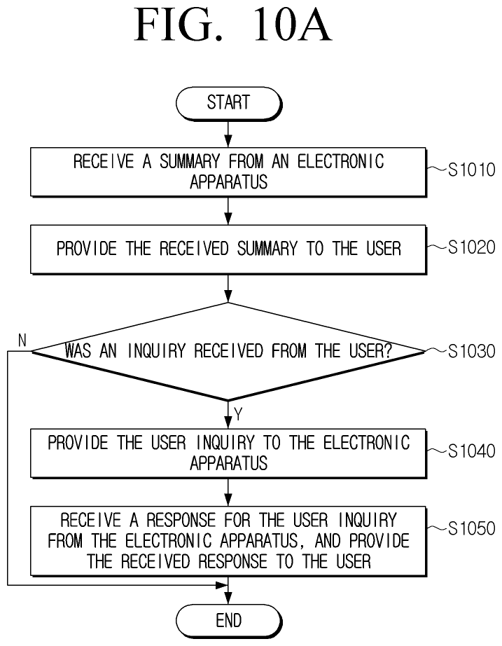

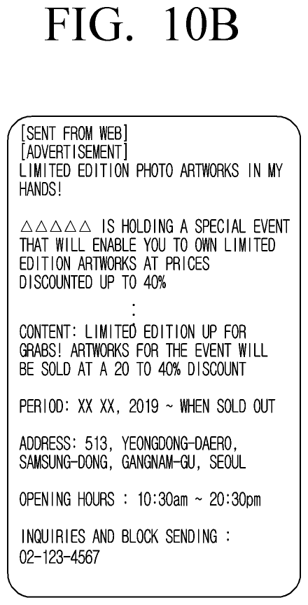

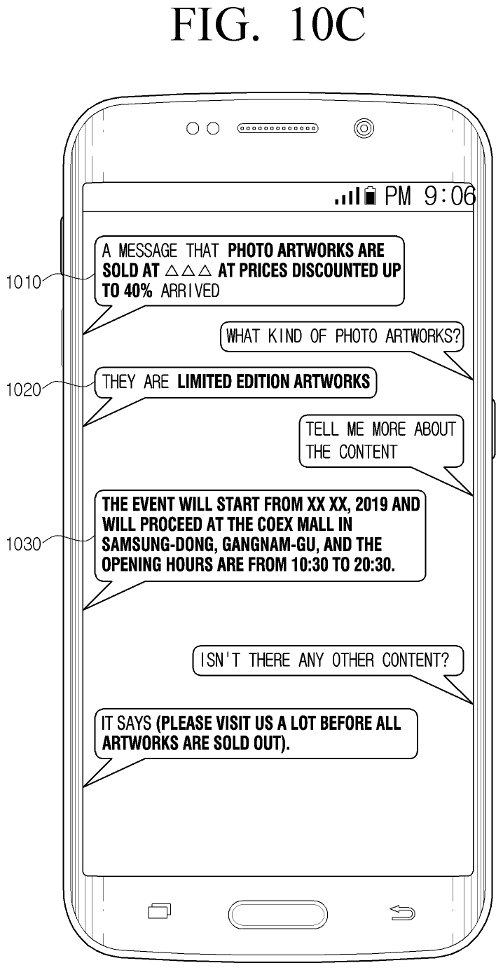

FIGS. 10A, 10B, and 10C are a flowchart and diagrams illustrating example operations of a user terminal apparatus according to an embodiment of the disclosure.

The user terminal apparatus 200 may receive a summary (or a summarized text) from the electronic apparatus 100 at operation S1010. The summary may refer, for example, to a summary that the electronic apparatus 100 generated using the conversation system and the summarization system based on an original document that the user terminal apparatus 200 received, as described above in FIGS. 1, 2, 3, 4, 5, 6, 7A, 7B, 7C, 8 and 9. For example, in case the user terminal apparatus 200 received an original document as in FIG. 10B, the electronic apparatus 100 may transmit a summary that summarized the original document in FIG. 10B to the user terminal apparatus 200, and the user terminal apparatus 200 may receive the summary from the electronic apparatus 100.

The received summary may be provided to the user at operation S1020. For example, the summary may be displayed through the display of the user terminal apparatus 200 as the text 1010 in FIG. 10C.

The user terminal apparatus 200 may receive a user inquiry from the user at operation S1030-Y. The user inquiry may be related to a specific keyword included in the summary such as ‘What kind of artwork is it?,’ or related to the summary such as ‘Tell me more about the content.’

In case a user inquiry was received from the user, the user inquiry may be provided to the electronic apparatus 100 at operation S1040. For example, in case the user inquiry was input as a voice, the user inquiry may be converted to a text using an ASR module and transmitted to the electronic apparatus 100. The electronic apparatus that received the user inquiry may generate a text corresponding to the user inquiry, and transmit the generated text to the user terminal apparatus.

The user terminal apparatus 200 may provide a response received from the electronic apparatus 100 at operation S1050. In case the user inquiry is an inquiry related to a specific keyword (e.g., ‘What kind of artwork is it?’), the response may be a text 1020 including information related to the keyword, and in case the user inquiry is related to the summary (e.g., ‘Tell me more about the content’ or ‘Summarize it to be shorter’), the response may be a text that described the summary in more detail 1030 or described the summary in a shortened form.

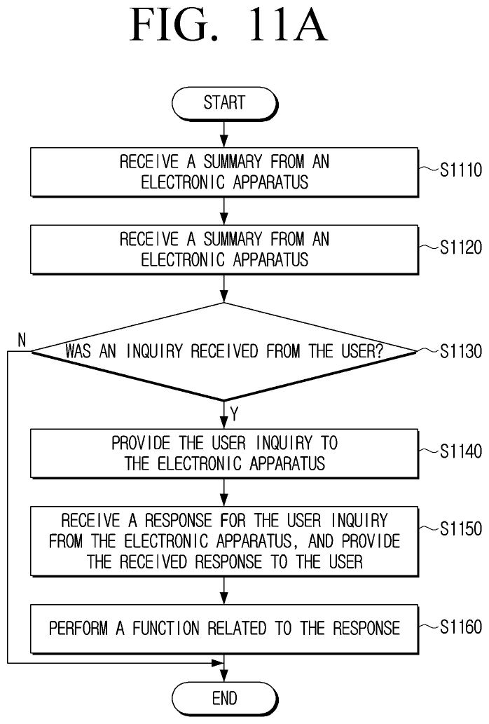

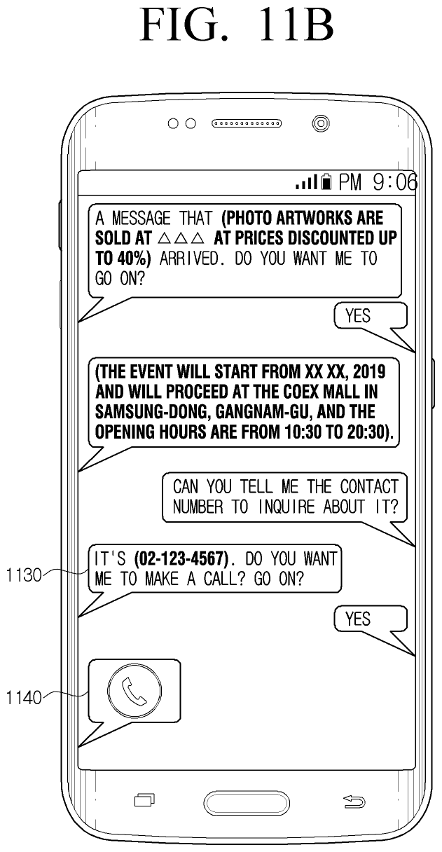

FIGS. 11A and 11B are a flowchart and a diagram illustrating example operations of a user terminal apparatus according to an embodiment of the disclosure. Regarding FIGS. 11A and 11B, explanation on portions overlapping with FIGS. 10A, 10B, and 10C may not be repeated here. For example, as S1110 to S1150 in FIG. 11A overlap with S1010 to S1050 in FIG. 10A, detailed explanation in this regard may not be repeated here.

When the user terminal apparatus 200 receives a response for a user inquiry from the electronic apparatus 100, the user terminal apparatus 200 may perform a function related to the response. For example, in case the user inquiry is related to a contact number, the user terminal apparatus 200 may receive a phone number from the electronic apparatus 100, and attempt connection of a call to the received phone number. For this, the user terminal apparatus 200 may make an inquiry related to whether to perform a function (e.g., Do you want me to make a call?) to the user, and display a text 1130 corresponding to the inquiry on the screen. In case the user requests the function, the user terminal apparatus 200 may perform the function, and display a UI 1140 or a text 1140 in this regard on the screen.

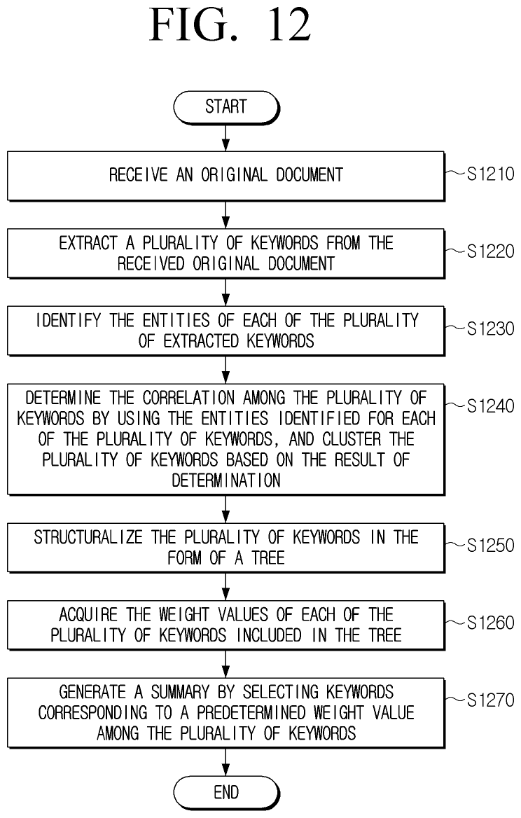

FIG. 12 is a flowchart illustrating an example method of controlling an electronic apparatus according to an embodiment of the disclosure. For example, FIG. 12 is a flowchart illustrating an example method for an electronic apparatus to generate a summary according to an embodiment of the disclosure.

An original document may be received at operation S1210. The original document is the same document that the user terminal apparatus 200 received, and the electronic apparatus 100 may receive the original document from the user terminal apparatus 200. However, this is merely an example, and the electronic apparatus 100 may receive the original document from a server (not shown) transmitting, keeping, and managing the original document of the user terminal apparatus 200.

A plurality of keywords may be extracted from the received original document at operation S1220, and the entities of each of the plurality of extracted keywords may be identified. For example, a plurality of keywords and entity information of the keywords included in the original document may be acquired based on a domain dictionary base storing a plurality of keywords and entity information for each of the plurality of keywords. For example, in case a word included in the original document is a keyword included in the domain dictionary base, the word may be extracted as a keyword and the entity information of the word may be identified from the domain dictionary base.

The correlation among the plurality of keywords may be determined using the entities identified for each of the plurality of keywords, and the plurality of keywords may be clustered based on the result of determination at operation S1240. For example, the correlation among the keywords may be determined using the domain dictionary base including entity information of keywords, and keywords related to one another may be clustered.

The plurality of keywords may be structuralized in the form of a tree at operation S1250. The plurality of clustered keywords may be structuralized in the form of a tree based on a domain knowledge base including a hierarchical structure among the entity information of the plurality of keywords.

The weight values of each of the plurality of keywords included in the tree may be acquired at operation S1260. For example, the weight values of each of the plurality of keywords included in the original document may be acquired using the weight values of the words stored in a keyword knowledge base and the entity information of the words.

A summary may be generated by selecting keywords corresponding to a predetermined weight value among the plurality of keywords. For example, a summary may be generated by selecting keywords of which weight values are greater than or equal to 0.5 among the plurality of keywords at operation S1270.

Computer instructions for executing the processing operations at the electronic apparatus 100 according to the various embodiments of the disclosure described above may be stored in a non-transitory computer-readable medium. Such computer instructions stored in a non-transitory computer-readable medium make the processing operations at the electronic apparatus 100 according to the various embodiments described above performed by a specific machine, when they are executed by a processor.

A non-transitory computer-readable medium may refer, for example, to a medium that stores data semi-permanently, and is readable by machines. For example, the aforementioned various applications or programs may be provided while being stored in a non-transitory computer-readable medium such as a CD, a DVD, a hard disc, a blue-ray disc, a USB, a memory card, a ROM and the like.

While the disclosure has been illustrated and described with reference to various example embodiments thereof, it will be understood that the various example embodiments are intended to be illustrative, not limiting. It will be further understood by one of ordinary skill in the art that various changes in form and detail may be made without departing from the true spirit and full scope of the disclosure, including the appended claims.

What is claimed is:

1. A method of controlling an electronic apparatus, comprising:
receiving an original document;
extracting a plurality of keywords from the received original document;
structuralizing the plurality of extracted keywords;
generating a summary for the received original document based on the plurality of structuralized keywords;
providing the generated summary;
receiving an inquiry for the provided summary; and
providing a response to the inquiry based on the plurality of structuralized keywords.

2. The method of claim 1,
wherein the providing a response to the inquiry comprises:
acquiring entity information of a keyword included in the inquiry; and
searching a keyword having an entity corresponding to the acquired entity information among the plurality of keywords included in the original document.

3. The method of claim 1,
wherein the structuralizing the plurality of keywords comprises:
identifying entities of each of the plurality of keywords included in the original document and generating structuralized keyword information for the original document based on the identified entities.

4. The method of claim 3,
wherein the providing a response to the inquiry comprises:
classifying keywords related to the inquiry using the structuralized keyword information.

5. The method of claim 3,
wherein the generating keyword information comprises:
clustering the plurality of keywords using the entities identified for each of the plurality of keywords; and
structuralizing the plurality of keywords in the form of a tree using the identified entities and generating keyword information.

6. The method of claim 5,
wherein the clustering the plurality of keywords comprises:
identifying entity information for each of the plurality of keywords using a first data base storing a plurality of words and entity information for each of the plurality of words; and
clustering the plurality of keywords using a second data base storing correlation for the plurality of entity information.

7. The method of claim 3, comprising:
receiving an additional original document;
identifying entities of each of the plurality of keywords included in the additional original document and generating structuralized keyword information for the additional original document based on the identified entities; and
based on relevance of the keyword information of the original document and the keyword information of the additional original document, incorporating the keyword information of the original document and the keyword information of the additional original document.

8. The method of claim 1,
wherein the generating a summary comprises:
acquiring weight values of each of the plurality of keywords included in the original document using the second data base storing weight values for a plurality of words,
selecting a keyword corresponding to a predetermined weight value among the plurality of keywords, and
generating the summary based on the selected keyword.

9. An electronic apparatus comprising:
a memory;
a communication interface comprising communication circuitry; and
a processor configured to control the electronic apparatus to:
receive an original document using the communication interface,
extract a plurality of keywords from the received original document,
structuralize the plurality of extracted keywords,
generate a summary for the received original document based on the plurality of structuralized keywords,
provide the generated summary, and
based on receiving an inquiry for the provided summary, provide a response to the inquiry based on the plurality of structuralized keywords.

10. The electronic apparatus of claim 9,
wherein the processor is configured to:
acquire entity information of a keyword included in the inquiry, and
search a keyword having an entity corresponding to the acquired entity information among the plurality of keywords included in the original document.

11. The electronic apparatus of claim 9,
wherein the processor is configured to:
identify entities of each of the plurality of keywords included in the original document and generate structuralized keyword information for the original document based on the identified entities.

12. The electronic apparatus of claim 11,
wherein the processor is configured to:
classify keywords related to the inquiry of the user using the structuralized keyword information.

13. The electronic apparatus of claim 11,
wherein the processor is configured to:
cluster the plurality of keywords using the entities identified for each of the plurality of keywords, and
structuralize the plurality of keywords in the form of a tree using the identified entities and generate keyword information.

14. The electronic apparatus of claim 13,
wherein the processor is configured to:
identify entity information for each of the plurality of keywords using a first data base storing a plurality of words and entity information for each of the plurality of words, and
cluster the plurality of keywords using a second data base storing correlation for the plurality of entity information.

15. The electronic apparatus of claim 11,
wherein the processor is configured to:
identify the entities of each of the plurality of keywords included in the additional original document and generate structuralized keyword information for the additional original document based on the identified entities, and
based on relevance of the keyword information of the original document and the keyword information of the additional original document, incorporate the keyword information of the original document and the keyword information of the additional original document.

16. The electronic apparatus of claim 15,
wherein the processor is configured to:
determine a degree of similarity between the keyword information of the original document and the keyword information of the additional original document, and determine whether to incorporate the keyword information of the original document and the keyword information of the additional original document based on the determined degree of similarity.

17. The electronic apparatus of claim 9,
wherein the processor is configured to:
acquire weight values for each of the plurality of keywords included in the original document, select a keyword corresponding to a predetermined weight value among the plurality of keywords, and generate the summary based on the selected keyword.

18. A non-transitory computer readable recording medium having recorded thereon a program which, when executed, causes an electronic apparatus to perform operations comprising:
receiving an original document;
extracting a plurality of keywords from the received original document;
structuralizing the plurality of extracted keywords;
generating a summary for the received original document based on the plurality of structuralized keywords;
providing the generated summary;
receiving an inquiry for the provided summary; and
providing a response to the inquiry based on the plurality of structuralized keywords.
